(19) United States
(12) Patent Application Publication
(10) Pub. No.: US 2019/0349805 A1
(43) Pub. Date: Nov. 14, 2019

(54) USER EQUIPMENTS AND METHODS FOR HANDLING AN UPDATE ON QUALITY OF SERVICE (QOS) FLOW TO DATA RADIO BEARER (DRB) MAPPING

(71) Applicant: MEDIATEK INC., Hsin-Chu (TW)

(72) Inventors: Ming-Yuan CHENG, Hsinchu (TW); Yu-Syuan JHENG, Hsinchu (TW); Pavan Santhana Krishna NUGGEHALLI, San Jose, CA (US)

(21) Appl. No.: 16/407,387

(22) Filed: May 9, 2019

Related U.S. Application Data
(60) Provisional application No. 62/717,115, filed on Aug. 10, 2018.
(60) Provisional application No. 62/670,090, filed on May 11, 2018.

(51) Int. Cl. H04W 28/02

(52) U.S. Cl. CPC H04W 28/0268; H04W 28/0263

(57) ABSTRACT

A UE including a wireless transceiver and a controller is provided. The controller constructs an end-marker control PDU for a QoS flow in response to a QoS flow to DRB mapping rule being configured for the QoS flow or in response to receiving a DL SDAP data PDU including an RDI set to 1 for the QoS flow, maps the end-marker control PDU to a default DRB in response to there being no stored QoS flow to DRB mapping rule for the QoS flow, maps the end-marker control PDU to a DRB according to a stored QoS flow to DRB mapping rule in response to the stored QoS flow to DRB mapping rule being different from the configured QoS flow to DRB mapping rule for the QoS flow, and sends the end-marker control PDU to the cellular station via the wireless transceiver.

### CROSS REFERENCE TO RELATED APPLICATIONS

This Application claims priority of U.S. Provisional Application No. 62/670,090, filed on May 11, 2018, the entirety of which is incorporated by reference herein. Also, this Application claims priority of U.S. Provisional Application No. 62/717,115, filed on Aug. 10, 2018, the entirety of which is incorporated by reference herein.

### BACKGROUND OF THE APPLICATION

### Field of the Application

The application generally relates to mobile communications, and more particularly, to User Equipments (UEs) and methods for handling an update on Quality of Service (QoS) flow to Data Radio Bearer (DRB) mapping.

### Description of the Related Art

In a typical mobile communication environment, a UE (also called a Mobile Station (MS)), such as a mobile telephone (also known as a cellular or cell phone), or a tablet Personal Computer (PC) with wireless communications capability, may communicate voice and/or data signals with one or more service networks. The wireless communication between the UE and the service networks may be performed using various cellular technologies, including Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, Time Division LTE (TD-LTE) technology, and others.

Particularly, GSM/GPRS/EDGE technology is also called the cellular technology; WCDMA/CDMA-2000/TD-SCDMA technology is also called 3G cellular technology; and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

According to the 3GPP specifications and/or requirements in compliance with the 5G NR, a Service Data Adaptation Protocol (SDAP) sublayer is responsible for Quality of Service (QoS) flow handling across the 5G air interface. In particular, the SDAP sublayer maintains a mapping between QoS flows within a PDU session and Data Radio Bearers (DRBs). In addition, the SDAP sublayer will mark the transmitted packets with the correct QFI (QoS Flow ID), ensuring that the packet receives correct forwarding treatment as it traverses the 5G System. For each PDU session, a single protocol entity of SDAP will be configured.

When an existing mapping for a particular QoS flow is changed either via an RRC procedure or reflective means, the SDAP sublayer will have to handle the update on the mapping. Specifically, packets belonging to this particular QoS flow, which are received from the higher layers of the SDAP sublayer after completion of the update, will be routed to the new DRB. However, the packets sent during the update may fail, and the current 3GPP specifications and/or requirements in compliance with the 5G NR do not address how to handle the retransmission of these packets and how to fulfill lossless packet delivery for the update on QoS flow to DRB mapping.

Therefore, it is desired to have a control mechanism to ensure that the packets belonging to a particular QoS flow are delivered in-sequence when an update on QoS flow to DRB mapping occurs.

### BRIEF SUMMARY OF THE APPLICATION

The present application proposes to fulfill lossless packet delivery for the update on QoS flow to DRB mapping, by providing a control mechanism which may ensure that the packets belonging to a particular QoS flow are delivered in-sequence when an update on QoS flow to DRB mapping occurs.

In one aspect of the application, a User Equipment (UE) comprising a wireless transceiver and a controller is provided. The wireless transceiver is configured to perform wireless transmission and reception to and from a cellular station. The controller is configured to construct an end-marker control Protocol Data Unit (PDU) for a Quality of Service (QoS) flow in response to a QoS flow to Data Radio Bearer (DRB) mapping rule being configured for the QoS flow or in response to receiving a Down-Link (DL) Service Data Adaptation Protocol (SDAP) data PDU comprising a RQoS flow to DRB mapping Indication (RDI) set to 1 for the QoS flow, map the end-marker control PDU to a default DRB in response to there being no stored QoS flow to DRB mapping rule for the QoS flow, map the end-marker control PDU to a DRB according to a stored QoS flow to DRB mapping rule in response to the stored QoS flow to DRB mapping rule being different from the configured QoS flow to DRB mapping rule for the QoS flow, and send the end-marker control PDU to the cellular station via the wireless transceiver.

In another aspect of the application, a method for handling an update on QoS flow to DRB mapping, executed by a UE communicatively connected to a cellular station, is provided. The method comprises the steps of: constructing an end-marker control PDU for a QoS flow in response to a QoS flow to DRB mapping rule being configured for the QoS flow or in response to receiving a DL SDAP data PDU comprising an RDI set to 1 for the QoS flow; mapping the end-marker control PDU to a default DRB in response to there being no stored QoS flow to DRB mapping rule for the QoS flow; mapping the end-marker control PDU to a DRB according to a stored QoS flow to DRB mapping rule in response to the stored QoS flow to DRB mapping rule being different from the configured QoS flow to DRB mapping rule for the QoS flow; and sending the end-marker control PDU to the cellular station.

Other aspects and features of the present application will become apparent to those with ordinarily skill in the art upon review of the following descriptions of specific embodiments of the UEs and the methods for handling an update on QoS flow to DRB mapping.

### BRIEF DESCRIPTION OF DRAWINGS

The application can be more fully understood by reading the subsequent detailed description and examples with references made to the accompanying drawings, wherein:

FIG. 1 is a block diagram of a wireless communication environment according to an embodiment of the application;

FIG. 2 is a block diagram illustrating the UE 110 according to an embodiment of the application;

FIG. 3 is a block diagram illustrating an exemplary structure of the SDAP sublayer according to an embodiment of the application;

FIG. 4 is a block diagram illustrating the functional view of the SDAP entity for the SDAP sublayer according to an embodiment of the application;

FIG. 5 is a flow chart illustrating the method for handling an update on QoS flow to DRB mapping according to an embodiment of the application;

FIGS. 6A and 6B show a flow chart illustrating the method for handling an update on QoS flow to DRB mapping according to another embodiment of the application;

FIG. 7 is a block diagram illustrating the format of an end-marker control PDU according to an embodiment of the application; and

FIG. 8 is a block diagram illustrating in-sequence QoS flow to DRB remapping according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

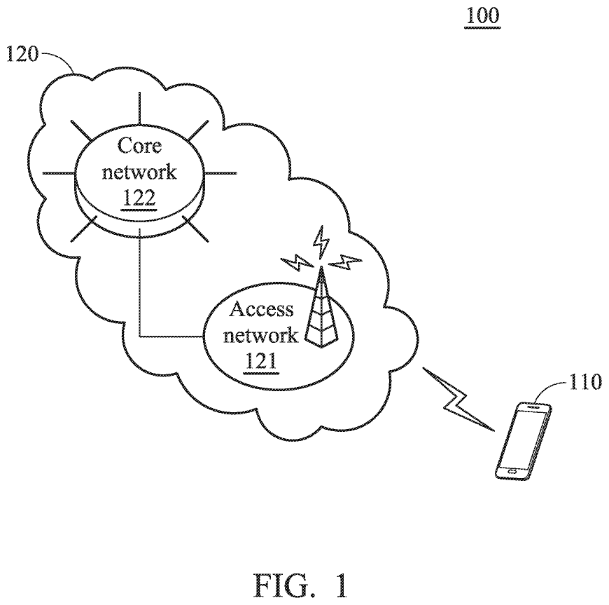

FIG. 1 is a block diagram of a wireless communication environment according to an embodiment of the application.

As shown in FIG. 1, the wireless communication environment 100 may include a User Equipment (UE) 110 and a service network 120, wherein the UE 110 may be wirelessly and communicatively connected to the service network 120 for obtaining mobile services.

The UE 110 may be a feature phone, a smartphone, a panel Personal Computer (PC), a laptop computer, or any wireless communication device supporting the cellular technology (e.g., the 5G NR technology) utilized by the service network 120. In another embodiment, the UE 110 may support more than one cellular technology. For example, the UE may support 5G NR technology and legacy 4G technology, such as LTE/LTE-A/TD-LTE technology, or WCDMA technology.

The service network 120 may include an access network 121 and a core network 122. The access network 121 is responsible for processing radio signals, terminating radio protocols, and connecting the UE 110 with the core network 122. The core network 122 is responsible for performing mobility management, network-side authentication, and interfaces with public/external networks (e.g., the Internet). The access network 121 and the core network 122 may each include one or more network nodes for carrying out said functions.

In one embodiment, the service network 120 may be a 5G NR network, and the access network 121 may be a Next Generation-Radio Access Network (NG-RAN) and the core network 122 may be a Next Generation Core Network (NG-CN).

An NG-RAN may include one or more cellular stations, such as next generation NodeBs (gNBs), which support high frequency bands (e.g., above 24 GHz), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

A 5G cellular station may form one or more cells with different Component Carriers (CCs) for providing mobile services to the UE 110. For example, the UE 110 may camp on one or more cells formed by one or more gNBs or TRPs, wherein the cells which the UE 110 is camped on may be referred to as serving cells, including a Primary cell (Pcell) and one or more Secondary cells (Scells).

A NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

It should be understood that the wireless communication environment 100 described in the embodiment of FIG. 1 are for illustrative purposes only and are not intended to limit the scope of the application. For example, the application may be applied to any future enhancement of 5G NR technology, or other cellular technologies with which the communication protocols associated include a Service Data Adaptation Protocol (SDAP) sublayer.

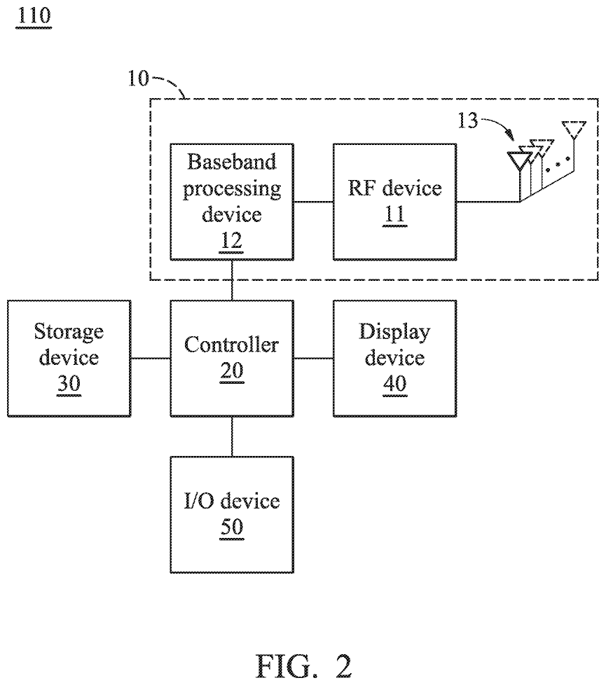

FIG. 2 is a block diagram illustrating the UE 110 according to an embodiment of the application.

As shown in FIG. 2, the UE 110 may include a wireless transceiver 10, a controller 20, a storage device 30, a display device 40, and an Input/Output (I/O) device 50.

The wireless transceiver 10 is configured to perform wireless transmission and reception to and from the cells formed by one or more cellular stations of the access network 121.

Specifically, the wireless transceiver 10 may include a Radio Frequency (RF) device 11, a baseband processing device 12, and antenna(s) 13, wherein the antenna(s) 13 may include one or more antennas for beamforming.

The baseband processing device 12 is configured to perform baseband signal processing and control the communications between subscriber identity card(s) (not shown) and the RF device 11. The baseband processing device 12 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 11 may receive RF wireless signals via the antenna(s) 13, convert the received RF wireless signals to baseband signals, which are processed by the baseband processing device 12, or receive baseband signals from the baseband processing device 12 and convert the received baseband signals to RF wireless signals, which are later transmitted via the antenna(s) 13. The RF device 11 may also contain multiple hardware devices to perform radio frequency conversion. For example, the RF device 11 may include a mixer to multiply the baseband signals with a carrier oscillated in the radio frequency of the supported cellular technologies, wherein the radio frequency may be any radio frequency (e.g., 30 GHz-300 GHz for mmWave) utilized in 5G NR technology, or another radio frequency, depending on the cellular technology in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless communications with the service network 120, storing and retrieving data (e.g., program code) to and from the storage device 30, sending a series of frame data (e.g. representing text messages, graphics, images, etc.) to the display device 40, and receiving user input or outputting signals via the I/O device 50.

In particular, the controller 20 coordinates the aforementioned operations of the wireless transceiver 10, the storage device 30, the display device 40, and the I/O device 50 for performing the method for handling an update on QoS flow to Data Radio Bearer (DRB) mapping.

In another embodiment, the controller 20 may be incorporated into the baseband processing device 12, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data (e.g., QoS flow to DRB mapping rule), instructions, and/or program code of applications, communication protocols, and/or the method for handling an update on QoS flow to DRB mapping.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 2 are for illustrative purposes only and are not intended to limit the scope of the application. For example, the UE 110 may include more components, such as a power supply, and/or a Global Positioning System (GPS) device, wherein the power supply may be a mobile/replaceable battery providing power to all the other components of the UE 110, and the GPS device may provide the location information of the UE 110 for use by some location-based services or applications. Alternatively, the UE 110 may include fewer components. For example, the UE 110 may not include the display device 40 and/or the I/O device 50.

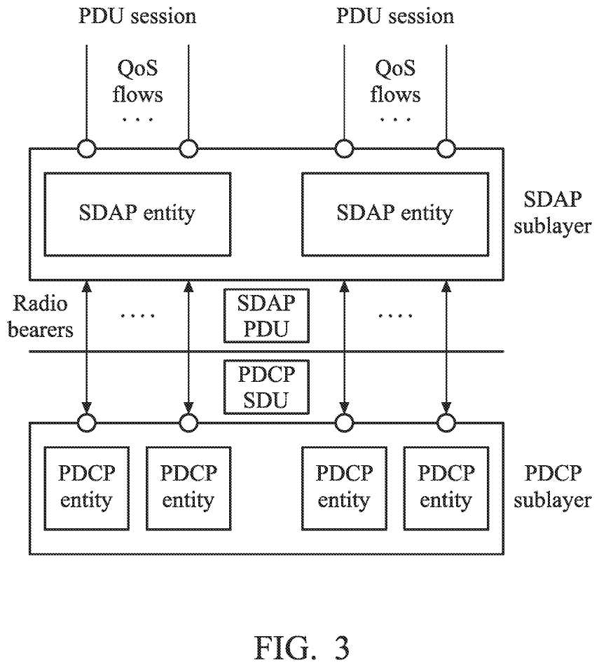

FIG. 3 is a block diagram illustrating an exemplary structure of the SDAP sublayer according to an embodiment of the application.

As shown in FIG. 3, a single protocol entity of SDAP may be configured for each Protocol Data Unit (PDU) session, wherein each PDU session may include multiple QoS flows. An SDAP entity may receive/deliver SDAP Service Data Units (SDUs) from/to upper layers (e.g., the Radio Resource Control (RRC) layer), and submit/receive SDAP data PDUs to/from its peer SDAP entity via lower layers (e.g., the Packet Data Convergence Protocol (PDCP) layer).

Specifically, each SDAP entity may be instantiated by a controller of a UE (e.g., the controller 20 of the UE 110).

The SDAP sublayer supports the following functions: transfer of user plane data; mapping between a QoS flow and a DRB for both Down-Link (DL) and Up-Link (UL); marking QoS flow ID in both DL and UL packets; and reflective QoS flow to DRB mapping for the UL SDAP data PDUs.

Please note that one or more QoS flows may be mapped onto one DRB, and one QoS flow is mapped onto only one DRB at a time in the UL.

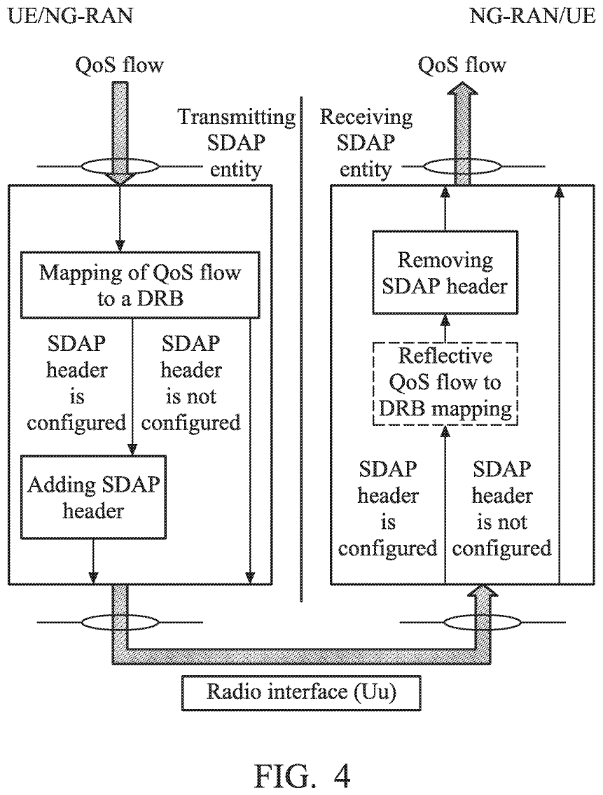

FIG. 4 is a block diagram illustrating the functional view of the SDAP entity for the SDAP sublayer according to an embodiment of the application.

As shown in FIG. 4, an SDAP entity receives/delivers SDAP SDUs from/to upper layers and submits/receives SDAP data PDUs to/from its peer SDAP entity via lower layers.

At the transmitting side, when an SDAP entity receives an SDAP SDU from upper layers, it constructs the corresponding SDAP data PDU and submits it to lower layers.

At the receiving side, when an SDAP entity receives an SDAP data PDU from lower layers, it retrieves the corresponding SDAP SDU and delivers it to upper layers.

Optionally, reflective QoS flow to DRB mapping is performed at UE if DL SDAP header is configured.

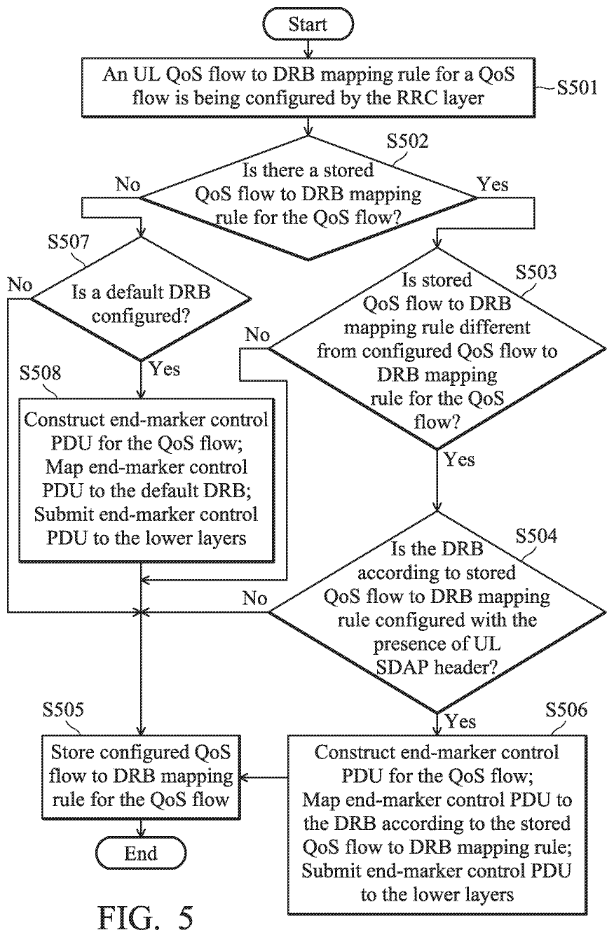

FIG. 5 is a flow chart illustrating the method for handling an update on QoS flow to DRB mapping according to an embodiment of the application.

In this embodiment, the method for handling an update on QoS flow to DRB mapping is applied to and executed by a UE (e.g., the UE 110) communicatively connected to a cellular station, and the update occurs due to configuration by the RRC layer.

To begin with, in the UE, an UL QoS flow to DRB mapping rule for a QoS flow is being configured by the RRC layer (step S501).

In one embodiment, the UL QoS flow to DRB mapping rule for the QoS flow may be configured by the RRC layer during a handover of the UE from one cellular station to another.

In another embodiment, the UL QoS flow to DRB mapping rule for the QoS flow may be configured by the RRC layer when reconfiguration of the UL QoS flow to DRB mapping rule for the QoS flow is requested by the cellular station via RRC signaling.

Next, the UE determines whether there is a stored QoS flow to DRB mapping rule for the QoS flow (step S502), and if so, determines whether the stored QoS flow to DRB mapping rule is different from the configured QoS flow to DRB mapping rule for the QoS flow (step S503).

Subsequent to step S503, if the stored QoS flow to DRB mapping rule is different from the configured QoS flow to DRB mapping rule for the QoS flow, the UE determines whether the DRB according to the stored QoS flow to DRB mapping rule is configured with the presence of UL SDAP header (step S504).

Subsequent to step S504, if the DRB according to the stored QoS flow to

DRB mapping rule is not configured with the presence of UL SDAP header, the UE stores the configured QoS flow to DRB mapping rule for the QoS flow (step S505), and the method ends.

Subsequent to step S504, if the DRB according to the stored QoS flow to DRB mapping rule is configured with the presence of UL SDAP header, the UE constructs an end-marker control PDU for the QoS flow, maps the end-marker control PDU to the DRB according to the stored QoS flow to DRB mapping rule, and submits the end-marker control PDU to the lower layers (step S506), and the method proceeds to step S505.

In one embodiment, before submitting the end-marker control PDU to the lower layers, the UE may wait until an indication from the PDCP layer is received, wherein the indication indicates that all outstanding PDCP PDUs on the DRB according to the stored QoS flow to DRB mapping rule have been successfully delivered to the cellular station.

Specifically, the end-marker control PDU is submitted to the lower layers to be sent to the cellular station.

Subsequent to step S503, if the stored QoS flow to DRB mapping rule is not different from the configured QoS flow to DRB mapping rule for the QoS flow, the method proceeds to step S505.

Referring back to step S502, if there is no stored QoS flow to DRB mapping rule for the QoS flow, the UE determines whether a default DRB is configured (step S507).

Subsequent to step S507, if a default DRB is configured, the UE constructs an end-marker control PDU for the QoS flow, maps the end-marker control PDU to the default DRB, and submits the end-marker control PDU to the lower layers (step S508), and the method proceeds to step S505.

Subsequent to step S507, if no default DRB is configured, the method proceeds to step S505.

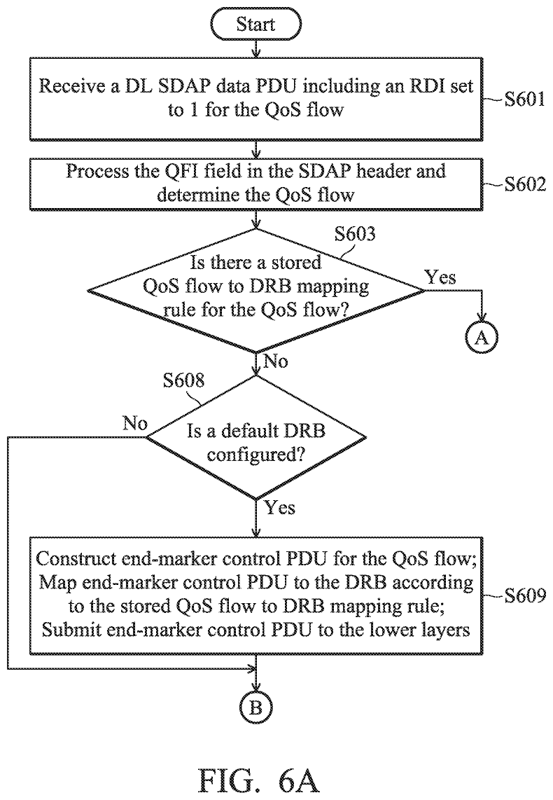

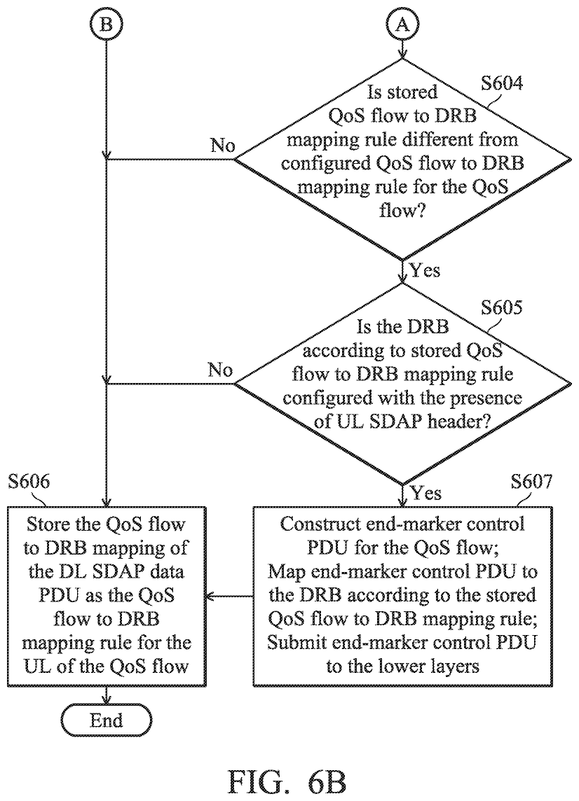

FIGS. 6A and 6B show a flow chart illustrating the method for handling an update on QoS flow to DRB mapping according to another embodiment of the application.

In this embodiment, the method for handling an update on QoS flow to DRB mapping is applied to and executed by a UE (e.g., the UE 110) communicatively connected to a cellular station, and the update occurs due to reflective mapping.

To begin with, the UE receives a DL SDAP data PDU including an RQoS flow to DRB mapping Indication (RDI) set to 1 for the QoS flow (step S601). Specifically, the RDI set to 1 means that reflective mapping should be applied.

Next, the UE processes the QoS Flow Identifier (QFI) field in the SDAP header and determines the QoS flow which the received DL SDAP data PDU is associated with (step S602).

After that, the UE determines whether there is a stored QoS flow to DRB mapping rule for the QoS flow (step S603), and if so, determines whether the stored QoS flow to DRB mapping rule is different from the QoS flow to DRB mapping of the DL SDAP data PDU (step S604).

Subsequent to step S604, if the stored QoS flow to DRB mapping rule is different from the QoS flow to DRB mapping of the DL SDAP data PDU, the UE determines whether the DRB according to the stored QoS flow to DRB mapping rule is configured with the presence of UL SDAP header (step S605).

Subsequent to step S605, if the DRB according to the stored QoS flow to DRB mapping rule is not configured with the presence of UL SDAP header, the UE stores the QoS flow to DRB mapping of the DL SDAP data PDU as the QoS flow to DRB mapping rule for the UL of the QoS flow (step S606), and the method ends.

Subsequent to step S605, if the DRB according to the stored QoS flow to DRB mapping rule is configured with the presence of UL SDAP header, the UE constructs an end-marker control PDU for the QoS flow, maps the end-marker control PDU to the DRB according to the stored QoS flow to DRB mapping rule, and submits the end-marker control PDU to the lower layers (step S607), and the method proceeds to step S606.

In one embodiment, before submitting the end-marker control PDU to the lower layers, the UE may wait until an indication from the PDCP layer is received, wherein the indication indicates that all outstanding PDCP PDUs on the DRB according to the stored QoS flow to DRB mapping rule have been successfully delivered to the cellular station.

Specifically, the end-marker control PDU is submitted to the lower layers to be sent to the cellular station.

Subsequent to step S604, if the stored QoS flow to DRB mapping rule is not different from the QoS flow to DRB mapping of the DL SDAP data PDU, the method proceeds to step S606.

Referring back to step S603, if there is no stored QoS flow to DRB mapping rule for the QoS flow, the UE determines whether a default DRB is configured (step S608).

Subsequent to step S608, if a default DRB is configured, the UE constructs an end-marker control PDU for the QoS flow, maps the end-marker control PDU to the default DRB, and submits the end-marker control PDU to the lower layers (step S609), and the method proceeds to step S606.

Subsequent to step S608, if no default DRB is configured, the method proceeds to step S606.

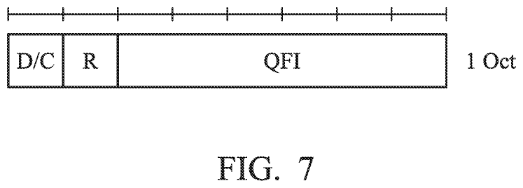

FIG. 7 is a block diagram illustrating the format of an end-marker control PDU according to an embodiment of the application.

As shown in FIG. 7, the end-marker control PDU is 1 octet long, wherein the D/C bit indicates whether the SDAP PDU is an SDAP Data PDU or an SDAP Control PDU, the R bit indicates the reserved bit, and the QFI bit indicates the ID of the QoS flow to which the SDAP PDU belongs.

Specifically, the D/C bit may be set to 0 to indicate that the SDAP PDU is an SDAP control PDU, and may be set to 1 to indicate that the SDAP PDU is an SDAP data PDU. The reserved bit may be set to 0 and should be ignored by the receiver.

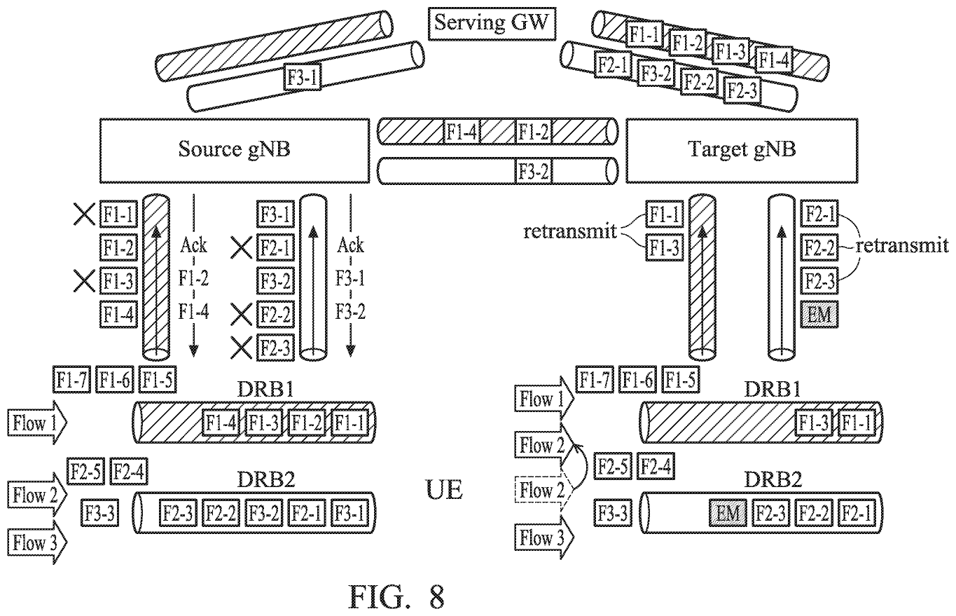

FIG. 8 is a block diagram illustrating in-sequence QoS flow to DRB remapping according to an embodiment of the application.

In this embodiment, the update occurs due to configuration by the RRC layer during a handover of the UE from one cellular station to another.

As shown in FIG. 8, a UE configured with three QoS flows is being handed over from a source gNB to a target gNB.

In particular, the second QoS flow was previously mapped to the second DRB, but once the handover is completed, the second QoS flow is mapped to the first DRB.

For the first QoS flow, the transmissions of the first and third packets before the completion of the handover have failed, and after the completion of the handover, the first and third packets are retransmitted on the same DRB since the QoS flow to DRB mapping rule for the first QoS flow has not changed.

For the second QoS flow, the transmissions of the first, second, and third packets before the completion of the handover have all failed, and after the completion of the handover, these three packets (which are also called outstanding PDUs) are retransmitted on the old DRB (i.e., DRB2) according to the stored QoS flow to DRB mapping rule, while other pending packets (denoted as F2-4 and F2-5 in FIG. 8) are to be transmitted on the new DRB (i.e., DRB1). In particular, after the outstanding packets are successfully delivered to the target gNB, the SDAP entity of the UE further sends an end-marker control PDU (denoted as EM in FIG. 8) on the second DRB to ensure that the packets of the QoS flow affected by the handover will be successfully received in-sequence.

In view of the forgoing embodiments, it should be appreciated that the present application realizes lossless packet delivery for the update on QoS flow to DRB mapping, by providing a control mechanism which may ensure that the packets belonging to a particular QoS flow are delivered in-sequence when an update on QoS flow to DRB mapping occurs. Specifically, the control mechanism enables the SDAP entity of the UE to send an end-marker control PDU on the old DRB (i.e., the DRB which the QoS flow was mapped to before the update) and start the transmission of new data on the new DRB (i.e., the DRB which the QoS flow is mapped to after the update), after the SDAP entity receives an indication from the PDCP layer, which indicates that all outstanding packets have been successfully delivered.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A User Equipment (UE), comprising:
a wireless transceiver, configured to perform wireless transmission and reception to and from a cellular station; and
a controller, configured to construct an end-marker control Protocol Data Unit (PDU) for a Quality of Service (QoS) flow in response to a QoS flow to Data Radio Bearer (DRB) mapping rule being configured for the QoS flow or in response to receiving a Down-Link (DL) Service Data Adaptation Protocol (SDAP) data PDU comprising a RQoS flow to DRB mapping Indication (RDI) set to 1 for the QoS flow, map the end-marker control PDU to a default DRB in response to there being no stored QoS flow to DRB mapping rule for the QoS flow, map the end-marker control PDU to a DRB according to a stored QoS flow to DRB mapping rule in response to the stored QoS flow to DRB mapping rule being different from the configured QoS flow to DRB mapping rule for the QoS flow, and send the end-marker control PDU to the cellular station via the wireless transceiver.

2. The UE of claim 1, wherein the mapping of the end-marker control PDU to the default DRB is performed further in response to an SDAP entity having been established and the default DRB being configured.

3. The UE of claim 1, wherein the mapping of the end-marker control PDU to the DRB according to the stored QoS flow to DRB mapping rule is performed further in response to the DRB according to the stored QoS flow to DRB mapping rule being configured with the presence of an Up-Link (UL) SDAP header.

4. The UE of claim 1, wherein the constructing of the end-marker control PDU for the QoS flow and the mapping of the end-marker control PDU to the default DRB or the DRB according to the stored QoS flow to DRB mapping rule are performed by an SDAP entity instantiated by the controller.

5. The UE of claim 4, wherein the SDAP entity further submits the end-marker control PDU to lower layers of the SDAP entity, so as to send the end-marker control PDU to the cellular station via the wireless transceiver.

6. The UE of claim 5, wherein the submitting of the end-marker control PDU to lower layers of the SDAP entity is performed in response to receiving, from a Packet Data Convergence Protocol (PDCP) layer, an indication that all outstanding PDCP PDUs on the default DRB or the DRB according to the stored QoS flow to DRB mapping rule have been successfully delivered to the cellular station.

7. The UE of claim 1, wherein the end-marker control PDU comprises only an SDAP header.

8. A method for handling an update on Quality of Service (QoS) flow to Data Radio Bearer (DRB) mapping, executed by a User Equipment (UE) communicatively connected to a cellular station, the method comprising:
constructing an end-marker control Protocol Data Unit (PDU) for a QoS flow in response to a QoS flow to DRB mapping rule being configured for the QoS flow or in response to receiving a Down-Link (DL) Service Data Adaptation Protocol (SDAP) data PDU comprising a RQoS flow to DRB mapping Indication (RDI) set to 1 for the QoS flow;
mapping the end-marker control PDU to a default DRB in response to there being no stored QoS flow to DRB mapping rule for the QoS flow;
mapping the end-marker control PDU to a DRB according to a stored QoS flow to DRB mapping rule in response to the stored QoS flow to DRB mapping rule being different from the configured QoS flow to DRB mapping rule for the QoS flow; and
sending the end-marker control PDU to the cellular station.

9. The method of claim 8, wherein the mapping of the end-marker control PDU to the default DRB is performed further in response to an SDAP entity having been established and the default DRB being configured.

10. The method of claim 8, wherein the mapping of the end-marker control PDU to the DRB according to the stored QoS flow to DRB mapping rule is performed further in response to the DRB according to the stored QoS flow to DRB mapping rule being configured with the presence of an Up-Link (UL) SDAP header.

11. The method of claim 8, wherein the constructing of the end-marker control PDU for the QoS flow and the mapping of the end-marker control PDU to the default DRB or the DRB according to the stored QoS flow to DRB mapping rule are performed by an SDAP entity instantiated by the UE.

12. The method of claim 11, wherein the SDAP entity further submits the end-marker control PDU to lower layers of the SDAP entity, so as to send the end-marker control PDU to the cellular station.

13. The method of claim 12, wherein the submitting of the end-marker control PDU to lower layers of the SDAP entity is performed in response to receiving, from a Packet Data Convergence Protocol (PDCP) layer, an indication that all outstanding PDCP PDUs on the default DRB or the DRB according to the stored QoS flow to DRB mapping rule have been successfully delivered to the cellular station.

14. The method of claim 8, wherein the end-marker control PDU comprises only an SDAP header.
